(19) United States
(12) Patent Application Publication
(10) Pub. No.: US 2019/0230735 A1
(43) Pub. Date: Jul. 25, 2019

(54) COMMUNICATION SYSTEM, CORE NETWORK DEVICE, COMMUNICATION METHOD, AND RECORDING MEDIUM IN WHICH PROGRAM IS RECORDED

(71) Applicant: NEC Corporation, Minato-ku, Tokyo (JP)

(72) Inventor: Satoki ABE, Tokyo (JP)

(73) Assignee: NEC Corporation, Minato-ku, Tokyo (JP)

(21) Appl. No.: 16/315,200

(22) PCT Filed: Jul. 11, 2017
(86) PCT No.: PCT/JP2017/025218

§ 371 Date: Jan. 4, 2019

(30) Foreign Application Priority Data
Jul. 15, 2016 (JP) 2016-140319

(51) Int. Cl. H04W 80/02; H04W 76/11; H04M 15/00; H04L 12/66; H04W 88/16

(52) U.S. Cl. CPC H04W 80/02; H04W 76/11; H04W 88/16; H04L 12/66; H04M 15/66

(57) ABSTRACT

A receiver is had that is constituted so as to receive first identification information indicating the Media Access Control (MAC) address of a terminal connected to a user device and second identification information indicating a port number of the user device. A core network device having a storage device constituted so as to store third identification information correlated to the first identification information, the third identification information identifying a policy for controlling a packet transmitted/received by the terminal. The core network device has a processor constituted so as to generate policy information that includes the second identification information and the third identification information.

### TECHNICAL FIELD

The present invention relates to a communication system, a core network device, a communication method, and a program.

### BACKGROUND ART

Patent Literature 1 discloses a user device having a mobile router function. The user device provides another terminal with connection using an access technology such as a wireless local area network.

### CITATION LIST

### Patent Literature

[PTL 1] Japanese National Publication of International Patent Application No. 2014-514784

### SUMMARY OF INVENTION

### Technical Problem

Patent Literature 1 discloses that a new bearer is established for each other terminal for the purpose of access.

However, in general, there is a limitation in the number of bearers that can be established.

An object of an exemplary example embodiment is to provide a new mechanism for controlling communication of a terminal which is connected to a user equipment. It is noted that this object is only one of a plurality of objects to be achieved by example embodiments disclosed in the present specification. Other objects or problems and new characteristics are apparent from description of the present specification and the accompanying drawings.

### Solution to Problem

A communication system, according to the exemplary example embodiment, includes: a user equipment; a terminal that is connected to the user equipment; and a core network device, wherein the user equipment transmits first identification information indicating a media access control (MAC) address of the terminal connected to the user equipment, and second identification information indicating a port number of the user equipment, and the core network device receives the first identification information and the second identification information, stores third identification information, the third identification information being associated with the first identification information and used to identify a policy for controlling a packet transmitted and received by the terminal, and generates policy information including the second identification information and the third identification information.

A core network device, according to the exemplary example embodiment, includes: a receiver configured to receive first identification information indicating a media access control (MAC) address of a terminal connected to a user equipment, and second identification information indicating a port number of the user equipment; a storage device configured to store third identification information, the third identification information being associated with the first identification information and used to identify a policy for controlling a packet transmitted and received by the terminal; and a processor configured to generate policy information including the second identification information and the third identification information.

A communication method, according to the exemplary example embodiment, includes: receiving first identification information indicating a media access control (MAC) address of a terminal connected to a user equipment, and second identification information indicating a port number of the user equipment; specifying third identification information, the third identification information being associated with the first identification information and used to identify a policy for controlling a packet transmitted and received by the terminal; and generating policy information including the second identification information and the third identification information.

A program, according to the exemplary example embodiment, causes a computer to execute: a process of receiving first identification information indicating a media access control (MAC) address of a terminal connected to a user equipment, and second identification information indicating a port number of the user equipment; a process of specifying third identification information, the third identification information being associated with the first identification information and used to identify a policy for controlling a packet transmitted and received by the terminal; and a process of generating policy information including the second identification information and the third identification information.

### Advantageous Effects of Invention

According to exemplary example embodiments of the present invention, it is possible to provide a new mechanism for controlling communication associated with a terminal which is connected to a user equipment.

### BRIEF DESCRIPTION OF DRAWINGS

FIG. 1 illustrates a communication system according to a first exemplary example embodiment.

FIG. 2 illustrates a user equipment of the first exemplary example embodiment.

FIG. 3 illustrates a terminal management system of the first exemplary example embodiment.

FIG. 4 illustrates an operation sequence of the first exemplary example embodiment.

FIG. 5 illustrates an operation sequence when communication is performed in the first exemplary example embodiment.

FIG. 6 illustrates a user equipment of a second exemplary example embodiment.

FIG. 7 illustrates a core network device of the second exemplary example embodiment.

FIG. 8 illustrates a communication system of the second exemplary example embodiment.

### EXAMPLE EMBODIMENT

Exemplary example embodiments will be described with reference to the drawings. In the present specification, at least one terminal is assumed to be a movable terminal. That is, not all terminals need to be always moving. In each drawing, the same reference numerals are given to the same or corresponding elements and redundant description is omitted when necessary in order to clarify description.

Furthermore, in the present specification and the drawings, there is a case where a plurality of elements having substantially the same functional configuration are distinguished from one another by adding an underscore (an underbar) and a numeral after the same reference numeral. For example, a plurality of elements having substantially the same functional configuration are distinguished from each other as with terminals 10_1 and 10_2 when necessary. However, when it is not particularly necessary to distinguish a plurality of elements having substantially the same functional configuration from one another, only the same reference numeral is added. For example, when it is not necessary to distinguish terminals 10_1 and 10_2 from each other, they are simply called a terminal 10.

A plurality of exemplary example embodiments to be described below can be independently performed or can also be performed through appropriate combinations thereof.

### Overview of Exemplary Example Embodiment

An exemplary example embodiment, for example, relates to a new mechanism that identifies terminals connected to a user equipment (UE) from one another in a 3rd generation partnership project (3GPP) network and performs policy management of the identified terminals.

### First Exemplary Example Embodiment

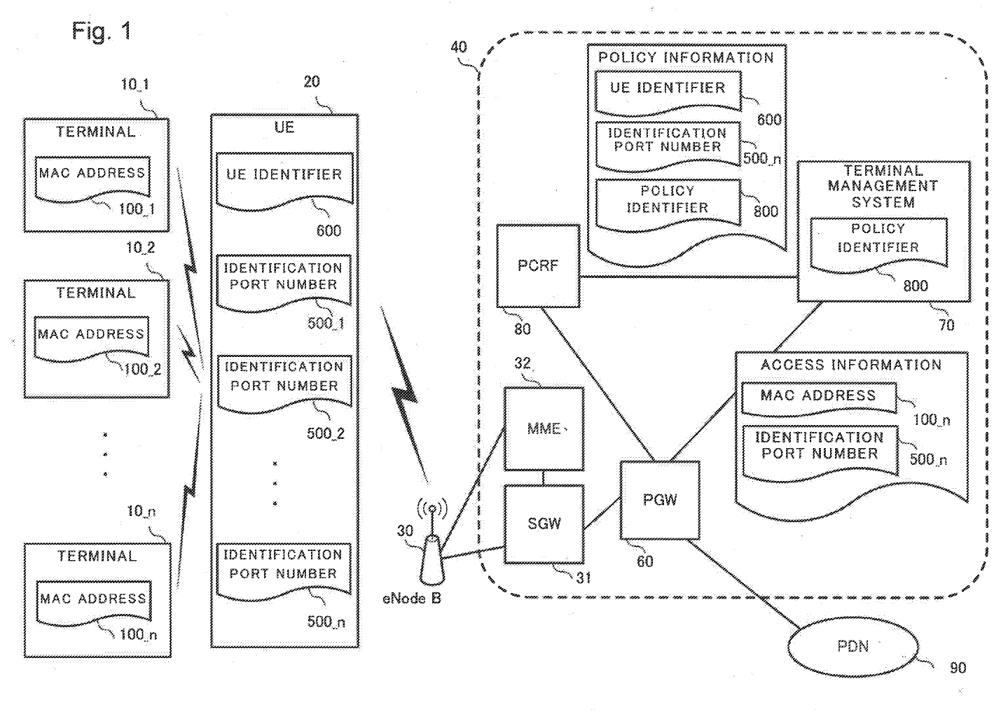

FIG. 1 illustrates an example of a communication system according to a first exemplary example embodiment. The communication system includes a terminal 10, a user equipment 20, an evolved Node B (eNode B) 30, a core network 40, and a packet data network (PDN) 90. The core network 40 includes a serving gateway (SGW) 31, a mobility management entity (MME) 32, a PDN gateway (PGW) 60, a terminal management system 70, and a policy and charging rules function (PCRF) 80.

The terminal 10 is a non-3GPP device. The terminal 10 is configured to be connectable to the user equipment 20. The terminal 10 is connected to the PDN 90 via the user equipment 20 by using a 3GPP network and can receive a service of the PDN 90. The 3GPP network includes at least an access network including the eNode B 30 and the core network 40. One MAC address 100 is allocated to the terminal 10. A MAC address 100_n is a physical address and can uniquely identify a terminal 10_n.

The user equipment 20 is configured to be connectable to the eNode B 30. Furthermore, the user equipment 20 is configured to be connectable to the terminal 10, and serves as a mobile wireless LAN router in the case of using a wireless local area network (LAN) technology in order to connect to the terminal 10. The user equipment 20 associates an identification port number 500_n, which is a randomly allocated port number, with the MAC address 100_n for identifying the terminal 10_n and stores them. Furthermore, the user equipment 20 has a UE identifier 600. The UE identifier 600 identifies the user equipment 20. The user equipment 20 transmits access information including the MAC address 100 and the identification port number 500 toward the terminal management system 70.

The eNode B 30 transmits the information received from the user equipment 20 to the core network 40. Furthermore, the eNode B 30 transmits information received from the core network 40 to the user equipment 20.

The SGW 31 is a device (a node) for connecting to the PGW 60 in order to connect to the PDN 90 which is an external network including the public Internet and the like. The SGW 31 has a user data transmission function of relaying a user packet between the eNode B 30 and the PGW 60.

The MME 32 transmits and receives a control signal between the eNode B 30 and the SGW 31.

The PGW 60 is connected to the terminal management system 70, the PCRF 80, and the PDN 90. The PGW 60 transmits the access information to the terminal management system 70. The PGW 60 receives policy information from the PCRF 80. The PGW 60 transmits the received data to the PDN 90 and transmits data received from the PDN 90 to the SGW 31.

The terminal management system 70 receives the access information transmitted by the user equipment 20. The terminal management system 70 correlates the MAC address 100_n included in the access information with a policy identifier 800. The terminal management system 70 transmits policy information including the policy identifier 800, the identification port number 500_n, and the UE identifier to the PCRF 80. The UE identifier 600 is identification information capable of uniquely specifying the user equipment 20. The UE identifier 600, for example, is an international mobile subscriber identity (IMSI). The terminal management system 70 associates the UE identifier 600 with the access information and stores them. It is noted that instead of the IMSI, a temporary mobile subscriber identity (TMSI) or a globally unique temporary UE identity (GUTI) may be used.

The PCRF 80 manages the identification port number 500_n of the user equipment 20. In this way, the PCRF 80 can manage a policy to be applied to communication of the terminal 10_n. For example, based on the acquired policy information, the PCRF 80 manages a policy for an identification port number_n of the UE identifier 600, and transmits policy information to the PGW 60 in order to control the PGW 60

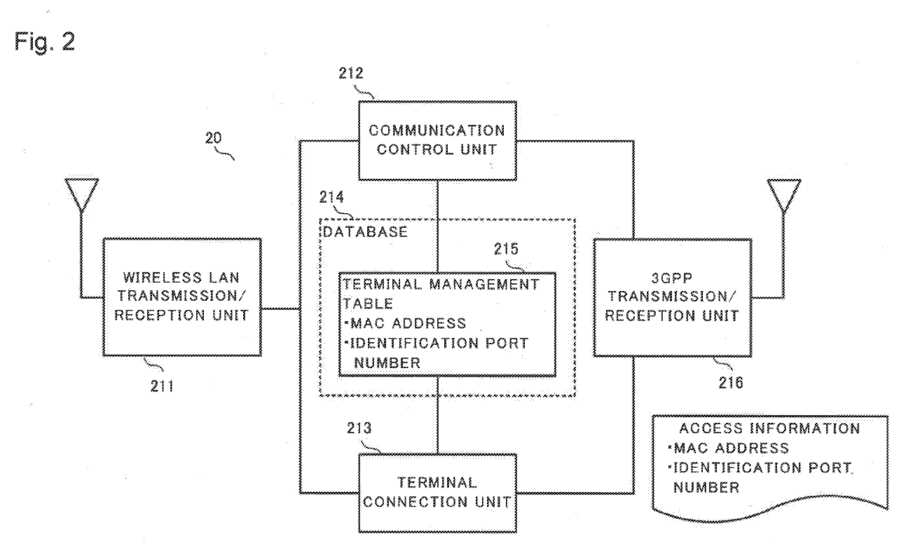

FIG. 2 illustrates the user equipment 20 of the first exemplary example embodiment.

The user equipment 20 includes a wireless LAN transmission/reception unit 211, a communication control unit 212, a terminal connection unit 213, a database 214, and a 3GPP transmission/reception unit 216. The database 214 is a storage device including a terminal management table 215.

The wireless LAN transmission/reception unit 211 transmits and receives a signal to/from the terminal 10.

The 3GPP transmission/reception unit 216 transmits and receives a signal to and from the 3GPP network.

The terminal connection unit 213 receives a connection request of the terminal 10 from the wireless LAN transmission/reception unit 211. The terminal connection unit 213 searches for the terminal management table 215 by using a MAC address included in the received connection request as a key. When the MAC address has not been stored in the terminal management table 215, a randomly allocated port number (also called an identification port number) is associated with the MAC address and is stored in the terminal management table 215. Furthermore, the terminal connection unit 213 transmits access information including the MAC address and the identification port number stored in the terminal management table 215 to the 3GPP transmission/reception unit 216.

The communication control unit 212 receives an IP packet whose transmission source is the terminal 10_n, from the wireless LAN transmission/reception unit 211 after connection with the terminal 10_n is completed. The communication control unit 212 searches for the terminal management table 215 by using the MAC address as a key, and specifies the identification port number. Furthermore, the communication control unit 212 converts a transmission source port number of the IP packet to an identification port number, and transmits the converted IP packet to the 3GPP transmission/reception unit 216.

The 3GPP transmission/reception unit 216 transmits, to the 3GPP network, the IP packet whose transmission source port number has been converted to the identification port number. Furthermore, the 3GPP transmission/reception unit 216 transmits the access information including the MAC address and the identification port number stored in the terminal management table 215 to the 3GPP network.

It is noted that when data stored in the terminal management table 215 disappears due to battery extinction of the user equipment 20, memory volatilization, hardware initialization and the like, a process for receiving a connection request from the terminal 10_n again and storing the connection request in the terminal management table 215 again may be performed.

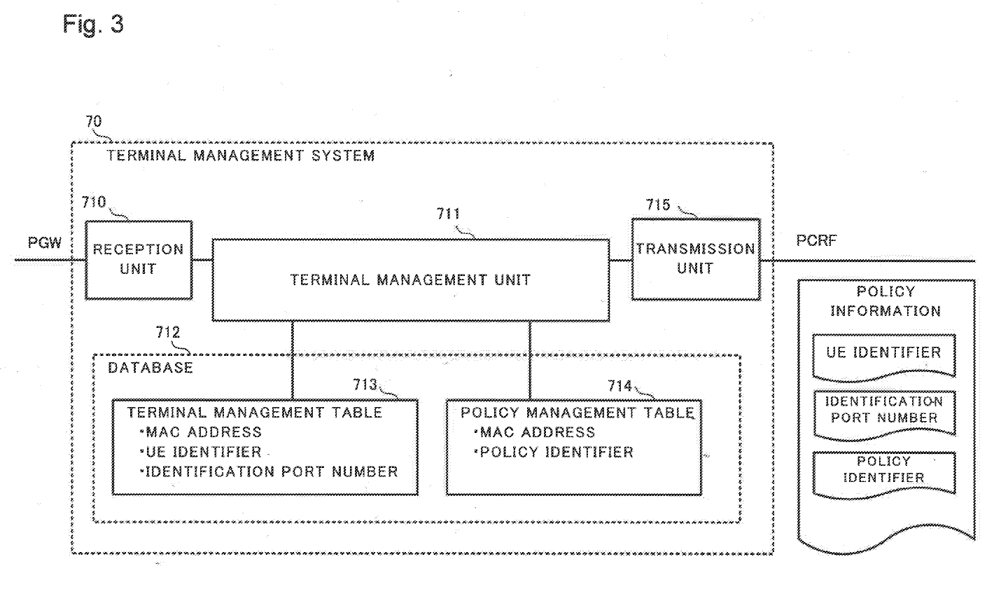

FIG. 3 illustrates the terminal management system 70 according to the first exemplary example embodiment.

The terminal management system 70 includes a reception unit 710, a terminal management unit 711, a database 712, and a transmission unit 715. The database 712 is a storage device including a terminal management table 713 and a policy management table 714.

The reception unit 710 receives the access information of the user equipment 20 from the PGW 60 and transmits the received access information to the terminal management unit 711.

The terminal management unit 711 receives the access information of the user equipment 20. The terminal management unit 711 checks whether the MAC address included in the access information has been stored in the terminal management table 713. When the MAC address has not been stored, the terminal management unit 711 associates the MAC address with the identification port number included in the access information and stores them in the terminal management table 713.

Furthermore, the terminal management unit 711 searches for the policy management table 714 by using the MAC address stored in the terminal management table 713 as a key. The terminal management unit 711 acquires a policy identifier corresponding to the MAC address, and generates policy information including the UE identifier, the identification port number, and the policy identifier.

The transmission unit 715 transmits the policy information generated in the terminal management unit 711 to the PCRF 80.

When the MAC address and the UE identifier which are associated and included in the access information received in the reception unit 710 have been stored in the terminal management table 713, the terminal management unit 711 determines that the identification port number has been updated. In such a case, the terminal management unit 711 overwrites and stores the identification port number included in the access information, and transmits the policy information including the overwritten identification port number to the PCRF 80.

The policy management table 714 may store in advance the policy identifier associated with the MAC address. The policy identifier associated with the MAC address may be updated based on information received from the outside of the terminal management system 70.

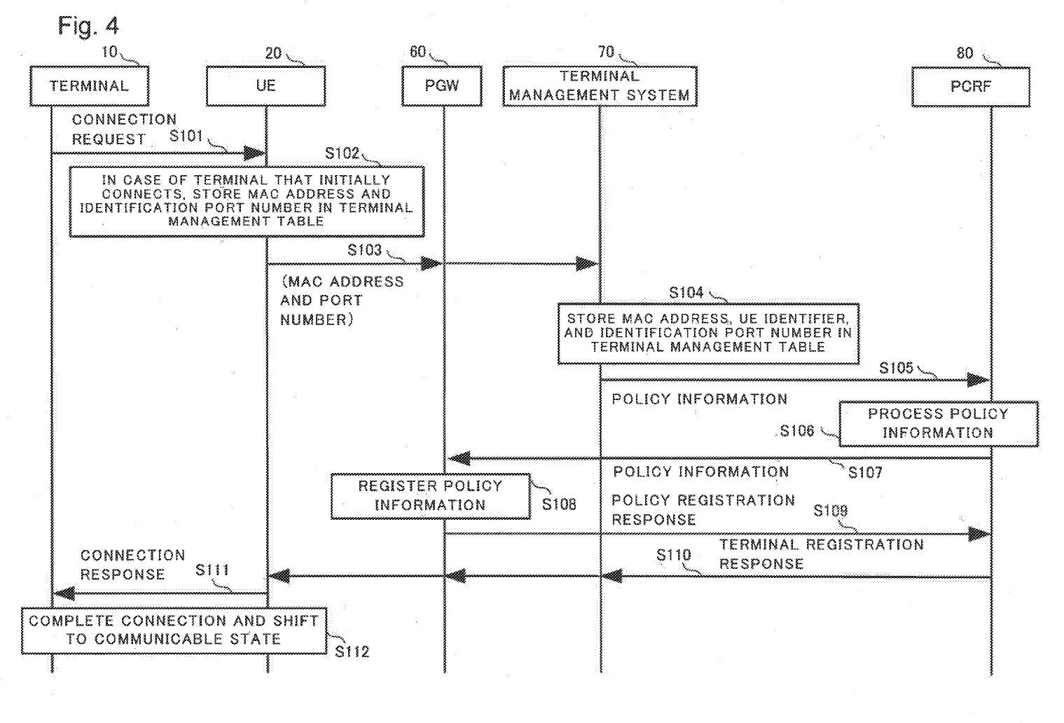

FIG. 4 illustrates an operation sequence of the first exemplary example embodiment.

In S101, the wireless LAN transmission/reception unit 211 of the user equipment 20 receives a connection request from the terminal 10.

In S102, when the connection request is initially received from the terminal 10, the terminal connection unit 213 associates a MAC address of the terminal 10 with a randomly allocated identification port number and stores them in the terminal management table 215.

In S103, the 3GPP transmission/reception unit 216 of the user equipment 20 transmits access information including the MAC address and the identification port number to the terminal management system 70. The access information is transmitted from the user equipment 20 to the terminal management system 70 via the eNode B 30, the SGW 31, and the PGW 60. The access information may include a UE identifier.

In S104, the terminal management unit 711 of the terminal management system 70 stores the MAC address of the terminal 10, the UE identifier, and the identification port number in the terminal management table 713.

In S105, the transmission unit 715 of the terminal management system 70 transmits policy information including the MAC address, the UE identifier, and a policy identifier associated with the identification port number to the PCRF 80, the MAC address, the UE identifier, and the identification port number being stored in the terminal management table 713.

In S106, the PCRF 80 processes the received policy information. For example, the PCRF 80 identifies a policy indicated by the policy identifier and an object (which may be specified from the UE identifier and the identification port number) to which the policy is applied.

In S107, the PCRF 80 transmits the policy information to the PGW 60.

In S108, the PGW 60 registers the policy information received from the PCRF 80.

In S109, the PGW 60 transmits, to the PCRF 80, a policy registration response indicating that the policy information has been registered.

In S110, the PCRF 80 transmits a terminal registration response to the terminal management system 70. The terminal management system 70 transmits the terminal registration response to the user equipment 20 via the PGW 60.

In S111, the user equipment 20 transmits a connection response to the terminal 10 having transmitted the connection request in S101.

In S112, connection between the terminal 10 and the user equipment 20 is completed. In this way, the terminal 10 can perform communication via the user equipment 20.

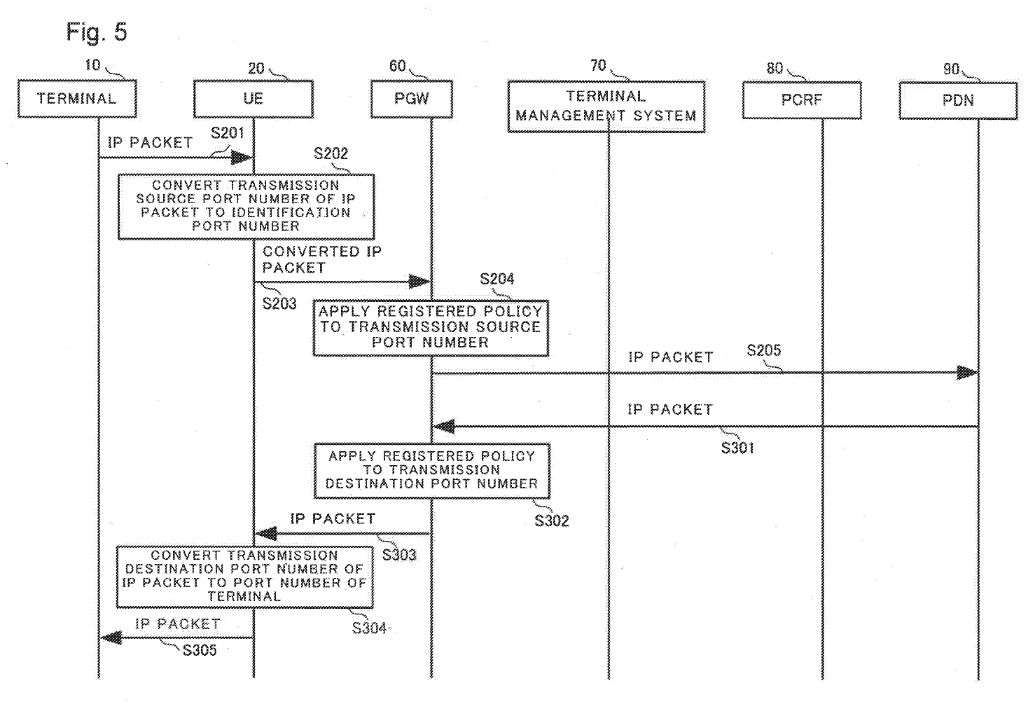

FIG. 5 illustrates an operation sequence when communication is performed in the first exemplary example embodiment.

In S201, the terminal 10 transmits an IP packet to the user equipment 20.

In S202, the communication control unit 212 of the user equipment 20 converts a transmission source port number of the received IP packet to an identification port number associated with the MAC address of the terminal 10.

In S203, the 3GPP transmission/reception unit 216 of the user equipment 20 transmits the IP packet converted in S202 to the PGW 60. The IP packet reaches the PGW 60 via the eNode B 30 and the SGW 31.

In S204, the PGW 60 applies a registered policy to the converted transmission source port number (the identification port number) of the IP packet.

In S205, the IP packet subjected to the policy is transmitted to the PDN 90.

In S201 to S205, an operation for the IP packet transmitted toward the PDN 90 from the terminal 10 has been described.

Subsequently, in S301 to S305, an operation for an IP packet transmitted toward the terminal 10 from the PDN 90 is described.

In S301, an IP packet reaches the PGW 60 from the PDN 90.

In S302, the PGW 60 confirms a transmission destination port number of the reached IP packet and determines that the IP packet is an IP packet addressed to the terminal 10. The PGW 60 applies a registered policy to the IP packet.

In S303, the PGW 60 transmits the IP packet to the user equipment 20.

In S304, the user equipment 20 converts the transmission destination port number of the IP packet to a port number of the terminal 10. For example, inverse conversion may be performed in S304 based on the information in which the port number (the transmission source port number of the IP packet transmitted from the terminal 10) of the terminal 10 is converted to the identification port number in S202. When the transmission destination port number of the IP packet in S303 is the identification port number, the transmission destination port number is converted to the port number of the terminal 10 from the identification port number in S304.

In S305, the user equipment 20 transmits, to the terminal 10, the IP packet whose transmission destination port number has been converted.

It is noted that in S202 and S304, the conversion of the port number has been described; however, an IP address may be converted.

According to the aforementioned exemplary example embodiment, it is possible to provide a new mechanism for controlling communication of a terminal connected to a user equipment.

Based on the policy information, the PCRF 80 can perform policy control (management) of the terminal 10 connected to the user equipment 20. The PGW 60 applies a policy to a packet which is transmitted and received using the identification port number 500 of the user equipment 20. In this way, application of a policy to the terminal 10 (policy control) is possible.

Furthermore, the core network side can perform policy management of the terminal 10 without a limitation of a bearer. This is because it is not necessary to establish an individual bearer with respect to the terminal 10. A plurality of terminals 10_1 to 10_n can share one bearer established between the user equipment 20 and a core network device, thereby performing communication (transmitting and receiving a packet). A policy for communication of each terminal 10 can be controlled regardless of the number of bearers. It is noted that the bearer is a bi-directional transmission path for transmitting information between the user equipment 20 and the PGW 60.

Even though the terminal 10 is a non-3GPP terminal, a core network device in the core network 40 can identify the terminal 10 as an object to which a policy is applied.

Furthermore, in a core network associated with a 3GPP standard, since it is not necessary to add a new function and/or setting to a device other than the PGW 60 and the PCRF 80, it is possible to construct a simple communication system. For example, an operator, such as a mobile virtual network operator, which does not have the MME 32 and has at least one of the PGW 60 and the PCRF 80, can perform policy control by using the communication system.

Furthermore, in order to perform policy management of the terminal 10, the user equipment 20 does not need to have a function for controlling a policy of the terminal 10 for example. That is, it is possible to prevent complication of the user equipment 20. In this way, by the exemplary example embodiment, it is possible to prevent an increase in the manufacturing cost of the user equipment 20, an increase in power consumption of the user equipment 20, and the like.

### Second Exemplary Example Embodiment

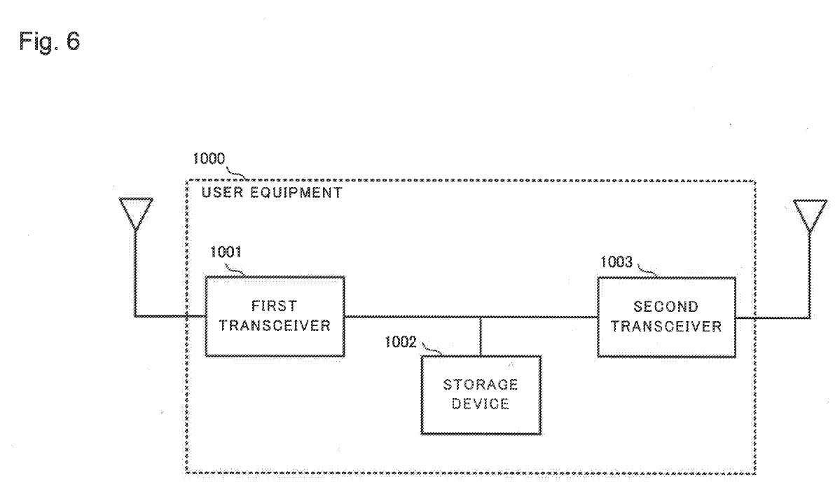

FIG. 6 illustrates a user equipment according to a second exemplary example embodiment. A user equipment 1000 includes a first transceiver 1001, a storage device 1002, and a second transceiver 1003. The first transceiver 1001 is configured to connect a terminal. The storage device 1002 is configured to associate first identification information for identifying a connected terminal with second identification information indicating a port number of the user equipment 1000 and store them. The second transceiver 1003 is configured to transmit, to a core network device, the first identification information and the second identification information which are associated with each other and stored, the core network device being for identifying a terminal.

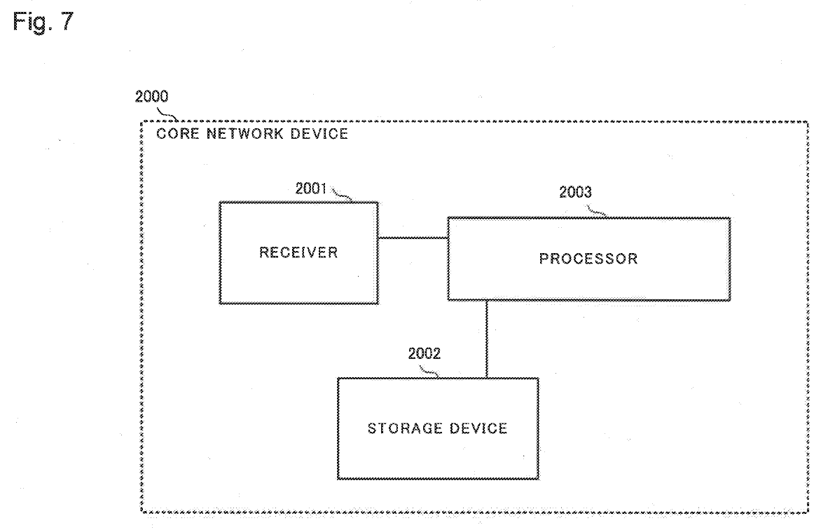

FIG. 7 illustrates a core network device according to the second exemplary example embodiment. A core network device 2000 includes a receiver 2001, a storage device 2002, and a processor 2003. The receiver 2001 is configured to receive first identification information indicating a MAC address of a terminal connected to a user equipment and second identification information indicating a port number of the user equipment. The storage device 2002 is configured to store third identification information, the third identification information being associated with the first identification information and used to identify a policy for controlling a packet transmitted and received by a terminal. The processor 2003 is configured to generate policy information including the second identification information and the third identification information.

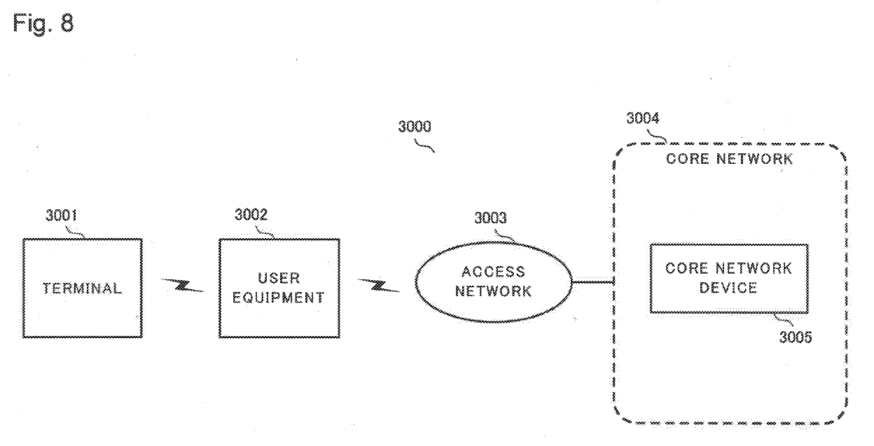

FIG. 8 illustrates a communication system of the second exemplary example embodiment. A communication system 3000 includes a terminal 3001, a user equipment 3002 to which the terminal 3001 is connected, an access network 3003, and a core network 3004 including a core network device 3005. The user equipment 3002 transmits first identification information indicating a MAC address of the terminal 3001 and second identification information indicating a port number of the user equipment 3002 to the access network 3003. The core network device 3005 receives the first identification information and the second identification information via the access network 3003 and the core network 3004. Furthermore, the core network device 3005 stores third identification information, the third identification information being associated with the first identification information and used to identify a policy for controlling a packet transmitted and received by the terminal 3001. Furthermore, the core network device 3005 generates policy information including the second identification information and the third identification information.

According to the aforementioned exemplary example embodiment, it is possible to provide a new mechanism for controlling communication associated with a terminal connected to a user equipment.

### Other Exemplary Example Embodiments

In the above, the policy control, for example, may be quality of service (QoS) control. For example, the QoS control is performed in both a wireless network section between the user equipment 20 and the eNode B 30, and a core network side. A parameter for processing QoS includes a QoS class identifier (QCI). By the QCI, a priority is stepwisely decided according to the presence or absence of band control, an allowable delay time, a packet loss rate and the like. For example, the QoS control is performed in each bearer according to the QCI in such a manner that 1 to 4 of the QCI correspond to a guaranteed bit rate (GBR) at which a band is guaranteed and 5 to 9 of the QCI correspond to a non-GBR at which a band is not guaranteed.

Furthermore, in the aforementioned example embodiments, a long term evolution (LTE) wireless communication system has been described as an example; however, at least some of methods and devices of various example embodiments can be applied to a wide range of communication systems including many non-LTE and/or non-cellular systems. For example, the aforementioned example embodiments may employ a universal mobile telecommunications system (UMTS) scheme.

Furthermore, a computer program (hereinafter, referred to as a program), in which processing details are described as a procedure, may be recorded on a storage medium readable by each element constituting a communication system (a wireless communication system), and the program recorded on the storage medium may be read and executed by each element of the communication system.

The program recorded on the storage medium is read by a central processing unit (CPU) provided to each element of the communication system, and a process similar to the above is performed under the control of the CPU. In such a case, the CPU operates as a computer that executes the program read from the storage medium recorded with the program.

In the aforementioned example, the program can be stored using various types of non-transitory computer readable media and be supplied to a computer. The non-transitory computer readable media include various types of tangible storage media. An example of the non-transitory computer readable media includes a magnetic storage medium (for example, a flexible disk, a magnetic tape, and a hard disk drive), a magneto-optical storage medium (for example, a magneto-optical disk), a compact disc (CD)-read only memory (ROM), a CD-R, a CD-R/W, a digital versatile disk (DVD) (registered trademark), and a semiconductor memory (for example, a mask ROM, a programmable ROM (PROM), an erasable PROM (EPROM), a flash ROM, and a random access memory (RAM)). Furthermore, the program may be supplied to a computer by various types of transitory computer readable media. An example of the transitory computer readable media includes an electrical signal, an optical signal, and an electromagnetic wave. The transitory computer readable media can supply the program to a computer via a wired communication path such as an electrical wire and an optical fiber, or a wireless communication path.

Moreover, the present invention is not limited only to the aforementioned example embodiments and it is of course that various modifications can be made without departing from the scope of the present invention already mentioned. Functions or steps and/or operations according to each example embodiment described in the present specification may not be performed in a specific order. Moreover, although elements of the present invention are described or claimed in a singular form, the elements may be a plural form as long as limitation to a singular form is not explicitly described.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### SUPPLEMENTARY NOTES

The whole or part of the example embodiments disclosed above can be described as, but not limited to, the following supplementary notes.

### Supplementary Note 1

A communication system comprising:

a user equipment;

a terminal that is connected to the user equipment; and

a core network device,

wherein the user equipment transmits first identification information indicating a media access control (MAC) address of the terminal connected to the user equipment, and second identification information indicating a port number of the user equipment, and

the core network device receives the first identification information and the second identification information, stores third identification information, the third identification information being associated with the first identification information and used to identify a policy for controlling a packet transmitted and received by the terminal, and generates policy information including the second identification information and the third identification information.

### Supplementary Note 2

The communication system according to Supplementary note 1, further comprising:

a gateway for connecting a core network including the core network device to an external network,

wherein a packet is transmitted and received via a bearer established between the gateway and the user equipment, the packet being related to a plurality of terminals connected to the user equipment.

### Supplementary Note 3

The communication system according to Supplementary note 1 or 2, wherein the core network device is included in a packet data network gateway (PGW) or a policy and charging rules function (PCRF) that controls the PGW.

### Supplementary Note 4

The communication system according to any one of Supplementary notes 1 to 3, wherein the user equipment converts a transmission source port number of a packet transmitted from the terminal to the port number indicated by the second identification information from a port number of the terminal.

### Supplementary Note 5

The communication system according to any one of Supplementary notes 1 to 4, wherein the user equipment converts a transmission source port number of a packet to the port number of the terminal from the port number indicated by the second identification information, the packet being transmitted toward the terminal from the user equipment.

### Supplementary Note 6

A core network device comprising:

a receiver configured to receive first identification information indicating a media access control (MAC) address of a terminal connected to a user equipment, and second identification information indicating a port number of the user equipment;

a storage device configured to store third identification information, the third identification information being associated with the first identification information and used to identify a policy for controlling a packet transmitted and received by the terminal; and

a processor configured to generate policy information including the second identification information and the third identification information.

### Supplementary Note 7

The core network device according to Supplementary note 6, wherein a packet related to a plurality of terminals, which are connected to the user equipment, is transmitted and received via a bearer established between a gateway and the user equipment, the gateway connecting a core network including the core network device to an external network.

### Supplementary Note 8

The core network device according to Supplementary note 6 or 7, wherein the core network device is included in a packet data network gateway (PGW) or a policy and charging rules function (PCRF) that controls the PGW.

### Supplementary Note 9

The core network device according to any one of Supplementary notes 6 to 8, wherein a transmission source port number of a packet transmitted from the terminal is converted to the port number indicated by the second identification information from a port number of the terminal.

### Supplementary Note 10

The core network device according to any one of Supplementary notes 6 to 9, wherein a transmission source port number of a packet is converted to the port number of the terminal from the port number indicated by the second identification information, the packet being transmitted toward the terminal from the user equipment.

### Supplementary Note 11

A communication method comprising:

receiving first identification information indicating a media access control (MAC) address of a terminal connected to a user equipment, and second identification information indicating a port number of the user equipment;

specifying third identification information, the third identification information being associated with the first identification information and used to identify a policy for controlling a packet transmitted and received by the terminal; and

generating policy information including the second identification information and the third identification information.

### Supplementary Note 12

The communication method according to Supplementary note 11, wherein a packet related to a plurality of terminals, which are connected to the user equipment, is transmitted and received via a bearer established between a gateway and the user equipment, the gateway connecting a core network to an external network.

### Supplementary Note 13

The communication method according to Supplementary note 11 or 12, wherein generation of the policy information is performed in a packet data network gateway (PGW) or a policy and charging rules function (PCRF) that controls the PGW.

### Supplementary Note 14

The communication method according to any one of Supplementary notes 11 to 13, wherein a transmission source port number of a packet transmitted from the terminal is converted to the port number indicated by the second identification information from a port number of the terminal.

### Supplementary Note 15

The communication method according to any one of Supplementary notes 11 to 14, wherein a transmission source port number of a packet is converted to the port number of the terminal from the port number indicated by the second identification information, the packet being transmitted toward the terminal from the user equipment.

### Supplementary Note 16

A storage medium recorded with a program causing a computer to execute:

a process of receiving first identification information indicating a media access control (MAC) address of a terminal connected to a user equipment, and second identification information indicating a port number of the user equipment;

a process of specifying third identification information, the third identification information being associated with the first identification information and used to identify a policy for controlling a packet transmitted and received by the terminal; and

a process of generating policy information including the second identification information and the third identification information.

### Supplementary Note 17

The storage medium recorded with the program according to Supplementary note 16, wherein the program causes the computer to execute a process of transmitting and receiving a packet related to a plurality of terminals, which are connected to the user equipment, via a bearer established between a gateway and the user equipment, the gateway connecting a core network to an external network.

### Supplementary Note 18

The storage medium recorded with the program according to Supplementary note 16 or 17, wherein the program causes the computer to execute a process of generating the policy information in a packet data network gateway (PGW) or a policy and charging rules function (PCRF) that controls the PGW.

### Supplementary Note 19

The storage medium recorded with the program according to any one of Supplementary notes 16 to 18, wherein the program causes the computer to execute a process of converting a transmission source port number of a packet transmitted from the terminal to the port number indicated by the second identification information from a port number of the terminal.

### Supplementary Note 20

The storage medium recorded with the program according to any one of Supplementary notes 16 to 19, wherein the program causes the computer to execute a process of converting a transmission source port number of a packet to the port number of the terminal from the port number indicated by the second identification information, the packet being transmitted toward the terminal from the user equipment.

This application is based upon and claims the benefit of priority from Japanese patent application No. 2016-140319, filed on Jul. 15, 2016, the disclosure of which is incorporated herein in its entirety by reference.

### REFERENCE SIGNS LIST

10 terminal

20 user equipment

30 eNode B

31 SGW

32 MME

40 core network

60 PGW

70 terminal management system

80 PCRF

90 PDN

100 MAC address

211 wireless LAN transmission/reception unit

212 communication control unit

213 terminal connection unit

214 database

215 terminal management table

216 3GPP transmission/reception unit

500 identification port number

600 UE identifier

710 reception unit

711 terminal management unit

712 database

713 terminal management table

714 policy management table

715 transmission unit

800 policy identifier

1000 user equipment

1001 first transceiver

1002 storage device

1003 second transceiver

2000 core network device

2001 receiver

2002 storage device

2003 processor

3000 communication system

3001 terminal

3002 user equipment

3003 access network

3004 core network

3005 core network device

What is claimed is:

1. A communication system comprising:
a user equipment;
a terminal that is connected to the user equipment; and
a core network device,
wherein the user equipment transmits first identification information indicating a media access control (MAC) address of the terminal connected to the user equipment, and second identification information indicating a port number of the user equipment, and
the core network device receives the first identification information and the second identification information, stores third identification information, the third identification information being associated with the first identification information and used to identify a policy for controlling a packet transmitted and received by the terminal, and generates policy information including the second identification information and the third identification information.

2. The communication system according to claim 1, further comprising:
a gateway for connecting a core network including the core network device to an external network,
wherein a packet is transmitted and received via a bearer established between the gateway and the user equipment, the packet being related to a plurality of terminals connected to the user equipment.

3. The communication system according to claim 1, wherein the core network device is included in a packet data network gateway (PGW) or a policy and charging rules function (PCRF) that controls the PGW.

4. The communication system according to claim 1, wherein the user equipment converts a transmission source port number of a packet transmitted from the terminal to the port number indicated by the second identification information from a port number of the terminal.

5. The communication system according to claim 1, wherein the user equipment converts a transmission source port number of a packet to a port number of the terminal from the port number indicated by the second identification information, the packet being transmitted toward the terminal from the user equipment.

6. A core network device comprising:
a receiver configured to receive first identification information indicating a media access control (MAC) address of a terminal connected to a user equipment, and second identification information indicating a port number of the user equipment;
a storage device configured to store third identification information, the third identification information being associated with the first identification information and used to identify a policy for controlling a packet transmitted and received by the terminal; and
a processor configured to generate policy information including the second identification information and the third identification information.

7. The core network device according to claim 6, wherein a packet related to a plurality of terminals, which are connected to the user equipment, is transmitted and received via a bearer established between a gateway and the user equipment, the gateway connecting a core network including the core network device to an external network.

8. The core network device according to claim 6, wherein the core network device is included in a packet data network gateway (PGW) or a policy and charging rules function (PCRF) that controls the PGW.

9. The core network device according to claim 6, wherein a transmission source port number of a packet transmitted from the terminal is converted to the port number indicated by the second identification information from a port number of the terminal.

10. The core network device according to claim 6, wherein a transmission source port number of a packet is converted to a port number of the terminal from the port number indicated by the second identification information, the packet being transmitted toward the terminal from the user equipment.

11. A communication method comprising:
receiving first identification information indicating a media access control (MAC) address of a terminal connected to a user equipment, and second identification information indicating a port number of the user equipment;
specifying third identification information, the third identification information being associated with the first identification information and used to identify a policy for controlling a packet transmitted and received by the terminal; and
generating policy information including the second identification information and the third identification information.

12. The communication method according to claim 11, wherein a packet related to a plurality of terminals, which are connected to the user equipment, is transmitted and received via a bearer established between a gateway and the user equipment, the gateway connecting a core network to an external network.

13. The communication method according to claim 11, wherein generation of the policy information is performed in a packet data network gateway (PGW) or a policy and charging rules function (PCRF) that controls the PGW.

14. The communication method according to claim 11, wherein a transmission source port number of a packet transmitted from the terminal is converted to the port number indicated by the second identification information from a port number of the terminal.

15. The communication method according to claim 11, wherein a transmission source port number of a packet is converted to a port number of the terminal from the port number indicated by the second identification information, the packet being transmitted toward the terminal from the user equipment.

16-20. (canceled)
